(19) United States
(12) Patent Application Publication
(10) Pub. No.: US 2026/0118651 A1
(43) Pub. Date: Apr. 30, 2026

(54) OPTICAL MODULE AND SMART HEAD-MOUNTED DEVICE

(71) Applicant: Goertek Optical Technology (Qingdao) Co., Ltd., Qingdao (CN)

(72) Inventors: Qi Sun, Qingdao (CN); Chun Yang, Qingdao (CN)

(73) Assignee: Goertek Optical Technology (Qingdao) Co., Ltd., Qingdao (CN)

(21) Appl. No.: 19/365,279

(22) Filed: Oct. 22, 2025

(30) Foreign Application Priority Data
Oct. 24, 2024 (CN) 202411498292.6

(51) Int. Cl. G02B 17/08; G02B 27/14; G02B 27/28; G06F 1/16

(52) U.S. Cl. CPC G02B 17/0856; G02B 27/142; G02B 27/283; G06F 1/163

(57) ABSTRACT

The disclosed subject matter provides an optical module and a smart head-mounted device. The optical module includes a display screen, a first lens, and a second lens arranged along the same optical axis; wherein the first lens is located between the display screen and the second lens, the first lens comprises a plano-concave lens having a planar surface thereof bonded to the display screen; the first lens has a light-splitting element provided on a surface thereof away from the display screen, the second lens has a phase retarder and a polarization-reflecting element stacked on a surface thereof close to the display screen, and the phase retarder is located between the light-splitting element and the polarization-reflecting element.

### CROSS-REFERENCE TO RELATED APPLICATION

This application claims priority to Chinese Patent Application No. 202411498292.6, filed on Oct. 24, 2024, which is hereby incorporated by reference in its entirety.

### TECHNICAL FIELD

Embodiments of the present disclosure relate to the field of optical display technology, and particularly to an optical module and a smart head-mounted device.

### BACKGROUND

With the rapid development of virtual reality technology, head-mounted display (HMD), as an important virtual reality device, has drawn wide attention to its performance and user experience. However, the HMD optical module in the prior art generally has the problems of large weight, long total optical length (TTL, i.e., the distance from the display screen to the exit pupil), easy generation of ghost images, and the like. These problems not only increase the wearing burden of users, but also may affect the imaging quality and visual experience.

Specifically, the HMD optical module in the prior art usually adopts a singlet folding optical path design, and on the premise of maintaining a certain field of view (FOV), the TTL is often greater than 18 mm, or even greater than 20 mm, and the total weight of all lenses is generally more than 20 g. In addition, in the assembly process of the optical module, the display screen is prone to defects due to particle contamination.

### SUMMARY

An objective of the present disclosure is to provide new solutions for an optical module and a smart head-mounted device.

In a first aspect, the present disclosure provides an optical module. The optical module includes a display screen, a first lens, and a second lens arranged along the same optical axis; wherein the first lens is located between the display screen and the second lens, the first lens is a plano-concave lens, and a planar surface of the first lens is bonded to the display screen;

a light-splitting element is provided on a surface of the first lens away from the display screen, a phase retarder and a polarization-reflecting element are stacked on a surface of the second lens close to the display screen, and the phase retarder is located between the light-splitting element and the polarization-reflecting element.

Optionally, an air gap is provided between the first lens and the second lens.

Optionally, the optical module satisfies:

$$20 mm < 1 / 3 {EFL}_{L 1} < {EFL}_{All} < 28 mm ;$$

$$20 mm < 1 / 3 {EFL}_{L 2} < {EFL}_{All} < 28 mm ;$$

$$0. 5 * TTL < T < 0.6 * TTL ;$$

wherein EFL_{L1} is a focal length of the first lens, EFL_{L2} is a focal length of the second lens, EFL_{AII} is a total focal length of the optical module, and T is a linear distance between a second surface of the first lens and a third surface of the second lens.

Optionally, the optical module satisfies:

$$- 50 mm < {R}_{21} < {R}_{12} < - 40 mm ;$$

$$- 5 < {R}_{22} / {R}_{21} < - 4 ;$$

$$2 mm < C {T}_{L 1} < C {T}_{L 2} < 4 mm ;$$

wherein R₁₂ is a radius of curvature of the second surface of the first lens, R₂₁ is a radius of curvature of the third surface of the second lens, R₂₂ is a radius of curvature of a fourth surface of the second lens, CT_{L1} is a center thickness of the first lens, and CT_{L2} is a center thickness of the second lens.

Optionally, the optical module satisfies:

$$2 mm < C {T}_{L 1} < C {T}_{L 2} < 4 mm ;$$

$$3 < E {T}_{L 1} / C {T}_{L 1} < 4 ;$$

$$0.3 < E {T}_{L 2} / C {T}_{L 2} < 0.5 ;$$

wherein CT_{L1} is a center thickness of the first lens, ET_{L1} is an edge thickness of the first lens, CT_{L2} is a center thickness of the second lens, and ET_{L2} is an edge thickness of the second lens.

Optionally, the optical module satisfies:

$$5 < C {A}_{L 1} / ( E {T}_{L 1} + C {T}_{L 1} ) < 6 ;$$

$$3 < C {A}_{L 2} / ( E {T}_{L 2} + C {T}_{L 2} ) < 4 ;$$

wherein CT_{L1} is the center thickness of the first lens, ET_{L1} is the edge thickness of the first lens, CA_{L1} is the clear aperture of the first lens, CT_{L2} is the center thickness of the second lens, ET_{L2} is the edge thickness of the second lens, and CA_{L2} is the clear aperture of the second lens.

Optionally, the optical module further includes a polarization element, which is provided on a surface of the polarization-reflecting element on a side away from the phase retarder.

Optionally, the light-splitting element is a transflective film, the phase retarder is a quarter-wave plate, the polarization-reflecting element is a polarization-reflecting film, and the polarization element is a polarizing film.

Optionally, when a FOV of the optical module is not less than 90°, an optical total length thereof is ≤17.5 mm.

In a second aspect, the present disclosure provides a smart head-mounted device, which includes:
a housing; and
the optical module according to the first aspect.

The beneficial effects of the present disclosure are:

the embodiments of the present disclosure provide an optical module, which can be applied to a head-mounted display (HMD), and can, under the premise of ensuring no degradation in imaging quality, achieve a significant reduction in the optical total length of the optical module and a reduction in the total weight of lenses by optimizing the lens design on the near-screen side and adding optical components such as a light-splitting element, a phase retarder, and a polarization-reflecting element at appropriate positions in the optical path, and simultaneously, can effectively suppress the generation of “ghost images”, thereby ensuring excellent imaging quality.

Other features and advantages of the present disclosure will become apparent from the following detailed description of exemplary embodiments of the present disclosure with reference to the accompanying drawings.

### BRIEF DESCRIPTION OF THE DRAWINGS

The accompanying drawings, which are incorporated in the description and constitute a part of the description, illustrate embodiments of the present disclosure and, together with the description thereof, serve to explain the principles of the present disclosure.

FIG. 1 shows a structure and optical path diagram of an optical module provided by an embodiment of the present disclosure;

FIG. 2 shows a spot diagram of the optical module provided by the embodiment of the present disclosure;

FIG. 3 shows a field curvature and distortion diagram of the optical module provided by the embodiment of the present disclosure.

### DESCRIPTION OF REFERENCE SIGNS

1. first lens; 11. first surface; 12. second surface; 2. second lens; 21. third surface; 22. fourth surface; 3. display screen; 4. light-splitting element; 5. phase retarder; 6. polarization-reflecting element; 7. polarization element; 01. human eye.

### DETAILED DESCRIPTION

Various exemplary embodiments of the present disclosure will now be described in detail with reference to the accompanying drawings. It is to be noted that unless otherwise specified, the scope of present disclosure is not limited to relative arrangements, numerical expressions and values of components and steps as illustrated in the embodiments.

Description to at least one exemplary embodiment is for illustrative purpose only, and in no way implies any restriction on the present disclosure or application or use thereof.

Techniques, methods and devices known to those skilled in the prior art may not be discussed in detail; however, such techniques, methods and devices shall be regarded as part of the description where appropriate.

In all the examples illustrated and discussed herein, any specific value shall be interpreted as illustrative rather than restrictive. Different values may be available for alternative examples of the exemplary embodiments.

It is to be noted that similar reference numbers and alphabetical letters represent similar items in the accompanying drawings. In the case that a certain item is identified in a drawing, further reference thereof may be omitted in the subsequent drawings.

The optical module and smart head-mounted device provided by embodiments of the present disclosure will be described in detail below with reference to the accompanying drawings.

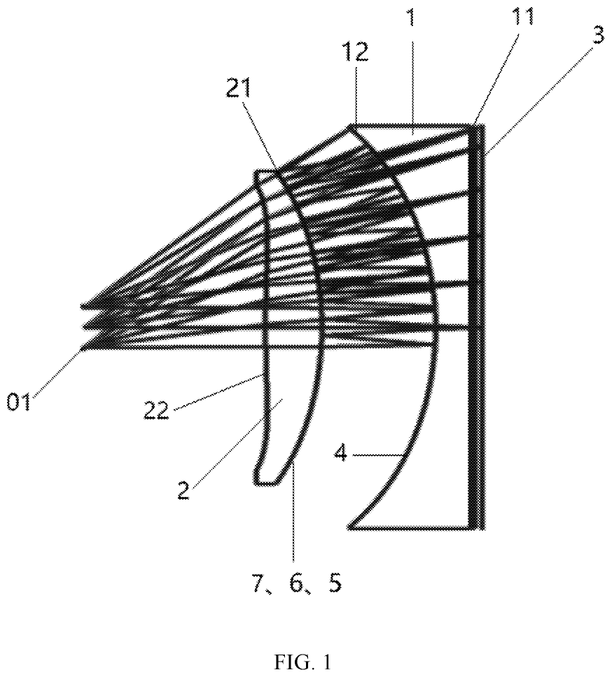

According to one embodiment of the present disclosure, an optical module is provided. Referring to FIG. 1, the optical module comprises a display screen 3, a first lens 1 and a second lens 2 arranged along the same optical axis; wherein the first lens 1 is located between the display screen 3 and the second lens 2, the first lens 1 is a plano-concave lens, and the planar surface of the first lens 1 is bonded to the display screen 3; a light-splitting element 4 is provided on a surface of the first lens 1 away from the display screen 3, a phase retarder 5 and a polarization-reflecting element 6 are stacked on a surface of the second lens 2 close to the display screen 3, and the phase retarder 5 is located between the light-splitting element 4 and the polarization-reflecting element 6.

The optical module provided by embodiments of the present disclosure involves multiple optical elements, each performing specific functions and working together to achieve good imaging effects and user experience. The following is an analysis of each optical element in the optical module of the embodiments of the present disclosure and a description of its technical effects.

The optical module provided by embodiments of the present disclosure comprises a display screen 3, which serves as a light source part of the entire optical module and can emit light for imaging display.

The optical module provided by embodiments of the present disclosure includes a first lens 1, which is located on a side close to the display screen 3, and the first lens 1 is designed as a plano-concave lens.

In the embodiments of the present disclosure, the display screen 3 and the first lens 1 are bonded together, so that the first lens 1 can be used to protect the display screen 3.

Specifically, referring to FIG. 1, the first surface 11 of the first lens 1 is a planar surface, which is bonded to a light-emitting surface of the display screen 3, thereby achieving a gapless connection. This tightly fitted design eliminates the gap that may exist in the conventional design, thereby effectively avoiding the risk of tiny particle (such as dust and impurities) contamination of the display screen 3. In the smart head-mounted device, any minor contamination may seriously affect imaging quality, so this design enhances the reliability and durability of the smart head-mounted device.

It should be noted that in the optical module provided by the embodiments of the present disclosure, the display screen 3, as a core component, has a relatively fragile light-emitting surface. Once contaminated, direct wiping or touching the light-emitting surface may cause irreversible damage, thereby affecting the display effect of the entire optical module. Considering that the manufacturing precision and cost of the display screen 3 are both relatively high, any form of physical damage will result in expensive repair or replacement costs, which undoubtedly increases product maintenance costs and usage risks.

Therefore, the optical solution of the present disclosure considered the protection of the display screen 3 as one of the design factors from the beginning. By designing the first surface 11 of the first lens 1 as a planar surface and directly bonding it to the light-emitting surface of the display screen 3, it is possible to effectively isolate the direct contact of the external environment to the display screen 3, thereby greatly reducing the risk of damage to the display screen 3.

The first lens 1 provided by the present disclosure is a plano-concave lens. The design of the plano-concave lens can also effectively control light divergence, making light more concentrated before entering the second lens 2, and reducing generation of stray light, which helps reduce the “ghost images” phenomenon.

The optical module provided by embodiments of the present disclosure includes a second lens 2. Referring to FIG. 1, the second lens 2 is located on a side of the first lens 1 away from the display screen 3. The second lens 2 can further focus light passing through the first lens 1 to form a clear image.

In addition to the aforementioned display screen 3, first lens 1 and second lens 2, the optical module provided by embodiments of the present disclosure further includes optical elements such as a light-splitting element 4, a phase retarder 5 and a polarization-reflecting element 6. The light-splitting element 4, phase retarder 5 and polarization-reflecting element 6 are designed to be located between the first lens 1 and the second lens 2 for achieving optical path folding.

Here, the light-splitting element 4 is located on the surface close to the first lens 1, namely the second surface 12, and is used to split light from the first lens 1 into two parts-one part transmits directly while the other part is reflected. The distribution of light and the change of path are realized by light splitting, which provides conditions for the subsequent phase delay and polarization reflection.

Here, the phase retarder 5 and polarization-reflecting element 6 are together provided on the surface of the second lens 2 close to the display screen 3, namely the third surface 21. Specifically, the phase retarder 5 is located after the light-splitting element 4, and alters the polarization state of light through phase retardation. The polarization-reflecting element 6 is located after the phase retarder 5, and performs polarization reflection on light adjusted by the phase retarder 5. Through polarization reflection, light is redirected and refocused, improving light utilization and imaging quality. Meanwhile, the selective reflection characteristics of the polarization-reflecting element 6 help reduce unnecessary reflections and interference, further suppressing generation of “ghost images”.

In one example, the light-splitting element 4 is a transflective film that can transmit part of light while reflecting another part. The phase retarder 5 is a quarter-wave plate for adjusting the phase of the light. The polarization-reflecting element 6 is a polarization-reflecting film, which is located after the phase retarder 5 and can reflect or transmit light based on its polarization state.

In the optical module provided by embodiments of the present disclosure, the combination of the light-splitting element 4, phase retarder 5 and polarization-reflecting element 6 together constitutes an efficient folded optical path. This design may not only shorten the optical total length (TTL) of the optical module, but also achieve multiple redirections and modulations of light, which is conducive to improving the imaging quality.

It should be noted that the optical module provided by the present disclosure adopts the design of folding the optical path between the air layers, which reduces the chaotic reflection of light between the lenses and also helps to reduce the generation of “ghost images”.

The embodiments of the present disclosure provide an optical module, which can be applied to a head-mounted display (HMD), and can, under the premise of ensuring no degradation in imaging quality, achieve a significant reduction in the optical total length of the optical module and a reduction in the total weight of lenses by optimizing the lens design on the near-screen side and adding optical components such as a light-splitting element 4, a phase retarder 5, and a polarization-reflecting element 6 at appropriate positions in the optical path, and simultaneously, can effectively suppress the generation of “ghost images”, thereby ensuring excellent imaging quality.

It should be particularly emphasized that the bonded design between the display screen 3 and the first lens 1 significantly reduces the risk of blemishes caused by particle contamination of the display screen during the assembly process. This optimization not only enhances the overall reliability of the optical module, but also remarkably improves the stability and durability of the final product, thereby providing users with a more reliable and stable user experience.

The optical module provided by embodiments of the present disclosure can deliver excellent user experience for applications such as virtual reality.

In some examples of the present disclosure, an air gap is provided between the first lens 1 and the second lens 2.

In these examples of the present disclosure, the air gap is provided between the first lens 1 and the second lens 2, and the light-splitting element 4, the phase retarder 5, and the polarization-reflecting element 6 are located in this air gap, allowing light to be folded within the air gap without passing through the lenses. This design may achieve the following technical effects:

reducing reflections and interference in the lenses: when light passes through the lenses, the reflections and interference may occur in the lenses, which may lead to occurrence of phenomena such as “ghost images”. By positioning the light-splitting element 4, the phase retarder 5, and the polarization-reflecting element 6 within the air gap, light will be reflected at an air-lens interface rather than in the lenses. This helps to reduce reflections and interference in the lenses, thereby reducing the occurrence of phenomena such as “ghost images”.

In addition, the air gap may also serve as a propagation medium for light, with a refractive index different from that of the lens material, which helps to further adjust the propagation path and focusing effect of the light, thereby optimizing the imaging quality.

In some embodiments of the present disclosure, referring to FIG. 1, the first lens 1 includes a first surface 11 and a second surface 12. The first surface 11 is a planar surface and bonded to the display screen 3, while the second surface 12 is concave, with the light-splitting element 4 disposed thereon.

The first lens 1 provided by the present disclosure includes two surfaces: the first surface 11 and the second surface 12. Here, the first surface 11 is designed as a planar surface to enable it to be tightly bonded with the display screen 3. The bonded connection between the first surface 11 of the first lens 1 and the display screen 3 reduces light loss within the air gap between them, thereby improving utilization efficiency of the light. Simultaneously, this bonded connection further enhances the stability between the first lens 1 and the display screen 3, contributing to maintaining the overall performance of the optical module.

Here, the concave design of the second surface 12 facilitates the convergence and divergence of light, further enhancing the imaging capability of the optical system. Moreover, the second surface 12 also provides a suitable substrate for the placement of the light-splitting element 4.

In the optical module provided by embodiments of the present disclosure, the light-splitting element 4 is provided on the second surface 12 of the first lens 1. Here, the light-splitting element 4 is, for example, a transflective film.

Specifically, the transflective film may be coated on the second surface 12 of the first lens 1, such that the light can be split according to a specific proportion when passing through that second surface 12, which facilitates the rational distribution of light within the optical module, and thus optimizes the overall optical path structure.

Furthermore, by directly disposing the light-splitting element 4 on the surface of the first lens 1, additional optical components and assembly steps are reduced, thereby lowering manufacturing and assembly costs.

In the present disclosure, by tightly bonding the first lens 1 with the display screen 3, and providing the light-splitting element 4 on the surface of the first lens 1, the entire optical module is more compact and integrated. This compact layout helps to reduce the volume of the optical module, and improves its application flexibility in devices such as virtual reality (VR) or augmented reality (AR).

In some embodiments of the present disclosure, referring to FIG. 1, the second lens 2 includes a third surface 21 and a fourth surface 22. The third surface 21 is adjacent to and spaced apart from the second surface 12, and the phase retarder 5 and the polarization-reflecting element 6 are stacked and provided on the third surface 21.

The second lens 2 provided by the present disclosure includes two surfaces: the third surface 21 and the fourth surface 22. Here, the third surface 21 is adjacent to but spaced apart from the second surface 12 of the first lens 1. This air gap provides necessary space for light transmission between the lenses and allows optical components to be provided on the third surface 21.

In the optical module provided by embodiments of the present disclosure, the phase retarder 5 and the polarization-reflecting element 6 are directly stacked and provided on the third surface 21 of the second lens 2. Here, the primary function of the phase retarder 5 is to adjust the phase of light, enabling precise control of its polarization state. The polarization-reflecting element 6 can reflect or transmit light based on its polarization direction, further manipulating the transmission path of the light. The stacking of the phase retarder 5 and the polarization-reflecting element 6 on the third surface 21 allows them to jointly act on passing light, achieving the fine control over the polarization state and transmission path of the light. This synergistic effect helps to optimize the performance of the optical module and improve the imaging quality. Such optical adjustment helps to reduce stray light and the “ghost images” phenomenon, thereby improving the image clarity.

Additionally, stacking the phase retarder 5 and the polarization-reflecting element 6 on the third surface 21 of the second lens 2 may also enable a compact layout of the optical components. This layout helps to reduce the volume of the optical module, improving its integration level and application flexibility.

Optionally, an anti-reflection coating may be applied to the fourth surface 22 of the second lens 2.

The primary function of the anti-reflection coating is to increase the amount of light transmitted through the lenses by reducing reflections of light at surfaces of the lenses. In devices such as the virtual reality (VR), improving light transmittance helps to enhance brightness and clarity of the image.

It should be noted that reducing reflected light may decrease direct stimulation of light to the eyes, particularly in high-light environments, thereby reducing eye fatigue and improving comfort during prolonged use of VR devices.

Furthermore, the anti-reflection coating may maintain color balance in light, and reduce color distortion caused by reflections, such that the transmitted light is closer to the color of the original light source, thereby improving the color reproduction of the image.

In some examples of the present disclosure, the optical module satisfies the following relationships:

$$20 mm < 1 / 3 {EFL}_{L 1} < {EFL}_{All} < 28 mm ;$$

$$20 mm < 1 / 3 {EFL}_{L 2} < {EFL}_{All} < 28 mm ;$$

$$0. 5 * TTL < T < 0.6 * TTL ;$$

wherein EFL_{L1} is a focal length of the first lens 1, EFL_{L2} is a focal length of the second lens 2, EFL_{AII} is a total focal length of the optical module, and T is a linear distance between a second surface 12 of the first lens 1 and a third surface 21 of the second lens 2.

According to this example of the present disclosure, the design of the focal length of the first lens 1 is described, specifically: 20 mm<⅓ EFL_{L1}<EFL_{AII}<28 mm. This inequality shows that: one third of the focal length (EFL_{L1}) of the first lens 1 is greater than 20 mm, and the total focal length (EFL_{AII}) of the entire optical module is between one third of the focal length of the first lens 1 and 28 mm. This ensures that the first lens 1 has a sufficient focal length to provide the desired imaging characteristics.

In this example of the present disclosure, the design of the focal length of the second lens 2 is also described, specifically: 20 mm<⅓ EFL_{L2}<EFL_{AII}<28 mm. For the second lens 2, one third of its focal length (EFL_{L2}) is also greater than 20 mm, and the total focal length of the entire optical module is also between one third of the focal length of the second lens 2 and 28 mm. This means that the focal lengths of both lenses have been carefully designed to ensure a balance in the overall performance of the entire optical module.

This example of the present disclosure also describes the design of the air gap between the first lens 1 and the second lens 2, namely 0.5*TTL<T<0.6*TTL. This inequality defines a linear distance T (i.e., an air gap) between the second surface 12 of the first lens 1 and the third surface 21 of the second lens 2, which is between half and 60% of the total optical length (TTL) of the entire optical module. This design helps to control the refraction and scattering of light through the lenses, thereby improving the utilization of light and image quality.

According to this example of the present disclosure, it is possible to control the total optical length TTL of the entire optical module below 17.5 mm by precisely controlling the focal length of each lens and the air gap (i.e., T) between the two lenses, which may reduce the volume of the entire optical module.

At the same time, the whole optical module may transmit and focus light more effectively, and reduce the refraction and scattering loss of light. Fine control of the focal length and air gap also helps to reduce aberrations and distortions and improve image clarity. This enables the optical module to provide a more realistic and natural imaging effect.

In some examples of the present disclosure, the optical module satisfies the following relationship:

$$- 50 mm < {R}_{21} < {R}_{12} < - 40 mm ;$$

$$- 5 < {R}_{22} / {R}_{21} < - 4 ;$$

$$2 mm < C {T}_{L 1} < C {T}_{L 2} < 4 mm ;$$

wherein R₁₂ is a radius of curvature of the second surface 12 of the first lens 1, R₂₁ is a radius of curvature of the third surface 21 of the second lens 2, R₂₂ is a radius of curvature of a fourth surface 22 of the second lens 2, CT_{L1} is a center thickness of the first lens 1, and CT_{L2} is a center thickness of the second lens 2.

In this example of the present disclosure, −50 mm<R₂₁<R₁₂<−40 mm is described. This inequality indicates that the absolute value of the radius of curvature R₂₁ of the third surface 21 of the second lens 2 is smaller than the absolute value of the radius of curvature R₁₂ of the second surface 12 of the first lens 1, with both values falling within the range of −50 mm to −40 mm. Such design helps to control the refraction angle of light passing through the lenses, enabling the light to focus more tightly on the image surface.

In this example of the present disclosure, −5<R₂₂/R₂₁<−4 is also described. This inequality specifies the ratio relationship between the radius of curvature R₂₂ of the fourth surface 22 of the second lens 2 and the radius of curvature R₂₁ of the third surface 21. This ratio range ensures an appropriate curvature difference between the two surfaces of the second lens 2, thereby helping to further control the refraction and focusing characteristics of light.

In this example of the present disclosure, 2 mm<CT_{L1}<CT_{L2}<4 mm is also described. This inequality means that the center thickness of the two lenses is controlled within 2 mm to 4 mm, and the center thickness of the lens is also an important design parameter. The thinner center thickness of the lens helps to reduce the length of the propagation path of the light in the lens, thereby contributing to a smaller EFL. However, the thickness of the lens also requires a trade-off between ensuring sufficient mechanical strength and optical performance.

In the present disclosure, by carefully designing the surface radius of curvature and the center thickness of the lens, the entire optical module can achieve a smaller EFL. The smaller EFL means that the light can be focused more tightly on the image surface, thus improving the clarity and resolution of the image.

Moreover, in the present disclosure, the precise control of the surface radius of curvature and the center thickness of the lens also helps to reduce aberration and distortion and improve the imaging quality of the image. This enables the optical module to provide a more accurate and natural imaging effect.

In some examples of the present disclosure, the optical module satisfies the following relationship:

$$2 mm < C {T}_{L 1} < C {T}_{L 2} < 4 mm ;$$

$$3 < E {T}_{L 1} / C {T}_{L 1} < 4 ;$$

$$0.3 < E {T}_{L 2} / C {T}_{L 2} < 0.5 ;$$

wherein CT_{L1} is a center thickness of the first lens 1, ET_{L1} is an edge thickness of the first lens 1, CT_{L2} is a center thickness of the second lens 2, and ET_{L2} is an edge thickness of the second lens 2.

Relationship between CT_{L1} and CT_{L2}: CT_{L1} represents the center thickness of the first lens 1, and CT_{L2} represents the center thickness of the second lens 2. The above relational expression 2 mm<CT_{L1}<CT_{L2}<4 mm indicates that the center thicknesses of both lenses are controlled to be between 2 mm and 4 mm, and the center thickness of the second lens 2 is slightly larger than that of the first lens 1. This design not only ensures the structural strength of each lens, but also achieves lightweight.

Relationship between ET_{L1} and ET_{L2}: ET_{L1} represents the edge thickness of the first lens 1. The relational expression 3<ET_{L1}/CT_{L1}<4 indicates that the ratio of the edge thickness to the center thickness of the first lens 1 is between 3 and 4. This means that the edge thickness is larger than the center thickness, which helps to enhance the resistance of the lens to deformation while maintaining control of the overall weight.

Relationship between ET_{L2} and CT_{L2}: ET_{L2} represents the edge thickness of the second lens 2. The relational expression 0.3<ET_{L2}/CT_{L2}<0.5 indicates that the ratio of the edge thickness to the center thickness of the second lens 2 is between 0.3 and 0.5. The edge thickness ratio of the second lens 2 is lower than that of the first lens 1, which helps to further reduce weight while maintaining sufficient structural strength.

In some examples of the present disclosure, the optical module further satisfies the following relationship:

$$5 < C {A}_{L 1} / ( E {T}_{L 1} + C {T}_{L 1} ) < 6 ;$$

$$3 < C {A}_{L 2} / ( E {T}_{L 2} + C {T}_{L 2} ) < 4 ;$$

wherein CT_{L1} is the center thickness of the first lens 1, ET_{L1} is the edge thickness of the first lens 1, CA_{L1} is the clear aperture of the first lens 1, CT_{L2} is the center thickness of the second lens 2, ET_{L2} is the edge thickness of the second lens 2, and CA_{L2} is the clear aperture of the second lens 2.

CA_{L1} represents the clear aperture of the first lens 1. The relational expression 5<CA_{L1}/(ET_{L1}+CT_{L1})<6 indicates that the ratio between the clear aperture of the first lens 1 and its total thickness (edge thickness+center thickness) is between 5 and 6. The larger ratio helps to improve the optical performance of the lens, such as a wider field of view and better imaging quality, while maintaining lightweight.

CA_{L2} represents the clear aperture of the second lens. The relational expression 3<CA_{L2}/(ET_{L2}+CT_{L2})<4 indicates that the ratio between the clear aperture of the second lens 2 and its total thickness is between 3 and 4. By controlling the ratio, it is possible to optimize the optical performance and the structural strength of the lens while maintaining the lightweight thereof.

In the above two examples, by precisely controlling the proportional relationship between the center thickness, the edge thickness, and the clear aperture of the lens, the lightweight, it is possible to achieve lightweight, structural enhancement, and improved imaging quality of the optical module.

Further, when the optical module simultaneously meets the following relationship, it aims to further optimize the weight and better realize the lightweight of the optical module. The specific relationship is as follows:

$$2 mm < C {T}_{L 1} < C {T}_{L 2} < 4 mm ;$$

$$3 < E {T}_{L 1} / C {T}_{L 1} < 4 ;$$

$$0.3 < E {T}_{L 2} / C {T}_{L 2} < 0.5 ;$$

$$5 < C {A}_{L 1} / ( E {T}_{L 1} + C {T}_{L 1} ) < 6 ;$$

$$3 < C {A}_{L 2} / ( E {T}_{L 2} + C {T}_{L 2} ) < 4 ;$$

wherein CT_{L1} is the center thickness of the first lens 1, ET_{L1} is the edge thickness of the first lens 1, CA_{L1} is the clear aperture of the first lens 1, CT_{L2} is the center thickness of the second lens 2, ET_{L2} is the edge thickness of the second lens 2, and CA_{L2} is the clear aperture of the second lens 2.

In this example of the present disclosure, the center thicknesses of the two lenses are described, namely 2 mm<CT_{L1}<CT_{L2}<4 mm. This condition limits the range of center thickness for each lens, ensuring that the lenses are neither too thick to increase weight, nor too thin to affect manufacturing and optical performance.

Specifically, by controlling the thickness of the first lens 1 between 2 mm and 4 mm, and designing the center thickness of the second lens 2 to be slightly greater than that of the first lens 1, it is possible to achieve lightweight while maintaining structural strength.

In this example of the present disclosure, 3<ET_{L1}/CT_{L1}<4 is described; wherein ET_{L1} is the edge thickness of the first lens 1, and CT_{L1} is the center thickness of the first lens 1. This ratio condition ensures the rationality of the edge thickness relative to the center thickness of the first lens 1, helping to balance the rigidity and lightweight requirements of the lenses. The design of a larger edge thickness ratio may improve the resistance of the lenses to deformation while maintaining control of the overall weight.

In this example of the present disclosure, 0.3<ET_{L2}/CT_{L2}<0.5 is described; wherein ET_{L2} is the edge thickness of the second lens 2, and CT_{L2} is the center thickness of the second lens 2. Similar to the first lens 1, this condition limits the ratio of edge thickness to center thickness for the second lens 2 to achieve more reasonable weight distribution and mechanical performance. The lower ratio helps to further reduce the weight of the second lens while maintaining sufficient structural strength.

In this example of the present disclosure, 5<CA_{L1}/(ET_{L1}+CT_{L1})<6 is described; wherein CA_{L1} is the clear aperture of the first lens 1. This condition ensures a reasonable ratio between the clear aperture of the first lens 1 and its total thickness (edge thickness+center thickness). A larger ratio helps to improve the optical performance of the lens, such as a wider field of view and better imaging quality, while maintaining lightweight.

In this example of the present disclosure, 3<CA_{L2}/(ET_{L2}+CT_{L2})<4 is described; wherein CA_{L2} is the clear aperture of the second lens 2. Similar to the first lens 1, this condition limits the ratio between the clear aperture of the second lens 2 and its total thickness. By controlling this ratio, it is possible to optimize the optical performance and structural strength of the lens while maintaining lightweight thereof.

According to this example of the present disclosure, by controlling the ratios of the center thickness, edge thickness, and clear aperture for each lens, it is possible to achieve lightweight of the entire optical module. This is crucial for improving the wearing comfort of HMD devices.

Moreover, the reasonable design of the lens for thickness and proportions helps to reduce aberrations and ghost images, thereby improving imaging quality and field of view. Additionally, appropriate edge thickness and proportional design may enhance the resistance of the lens to deformation, thereby increasing the stability and durability of the optical module.

In some examples of the present disclosure, referring to FIG. 1, the optical module further includes a polarization element 7, which is provided on a surface of the polarization-reflecting element 6 on a side away from the phase retarder 5.

The optical module provided by embodiments of the present disclosure may also include the polarization element 7. The polarization element 7, the polarization-reflecting element 6, and the phase retarder 5 may be sequentially stacked to form a composite film, which can be directly attached to the third surface 21 of the second lens 2.

Herein, the composite film formed by the phase retarder 5, the polarization-reflecting element 6, and the polarization element 7 can precisely control the polarization direction and reflection path of light, reducing the loss and interference of the light. This design helps to eliminate or decrease image distortion and “ghost images” phenomenon caused by mismatched polarization states, thereby enhancing imaging clarity.

Optionally, an anti-reflection film may also be incorporated into the composite film, and be provided on the side of the phase retarder 5 away from the polarization-reflecting element 6.

The entire composite film possesses multiple functions, including polarization correction, phase retardation, and anti-reflection, and can further reduce reflection and interference of the light, thereby improving imaging quality.

In some examples of the present disclosure, the light-splitting element 4 is a transflective film, the phase retarder 5 is a quarter-wave plate, the polarization-reflecting element 6 is a polarization-reflecting film, and the polarization element 7 is a polarizing film.

In some examples of the present disclosure, when the FOV of the optical module is not less than 90°, its optical total length is ≤17.5 mm.

The optical module provided by embodiments of the present disclosure, referring to FIG. 1, incorporates one plano-concave lens (i.e., the first lens 1) on the side close to the display screen 3, and realizes optical path folding by using a plurality of optical films and air layers.

Please continue to refer to FIG. 1, light emitted from the display screen 3 enters the first lens 1 through the first surface 11 of the first lens 1, and approximately 50% of the light exits into the air gap (located between the first lens 1 and the second lens 2) after the light passes through the second surface 12; after being reflected by the optical films (including the phase retarder 5 and the polarization-reflecting element 6, etc.) attached to the third surface 21 of the second lens 2, the light returns to the air layer and is reflected again at the second surface 12, with 50% of the light reflected back into the air gap. Due to the change in the polarization direction, the light may enter the second lens 2 after passing through the third surface 21, and then enter the human eye 01 through the fourth surface 22 of the second lens 2. Here, this design achieves optical path folding between the air layers, and avoids the effects of internal stress birefringence.

The optical module of the present disclosure, through precise design of optical parameters such as curvature, thickness, and material of the first lens 1 and the second lens 2, reduces the optical total length (TTL) to 15.4 mm while maintaining an FOV of the whole optical module not less than 90°, and the combined weight of the two lenses is reduced to less than 9 g.

The optical module provided by embodiments of the present disclosure possesses high imaging quality. The spot size across the entire field of view is controlled to within approximately 66 micrometers, ensuring image clarity and providing users with a more realistic visual experience.

The following describes the present disclosure in detail through the first embodiment.

### First Embodiment

Referring to FIG. 1, the optical module includes a display screen 3, a first lens 1, and a second lens 2 arranged sequentially along the same optical axis.

Here, the first lens 1 is a plano-concave lens, includes a first surface 11 and a second surface 12, and is planar and bonded to the display screen 3, while the second surface 12 is concave and coated with a light-splitting element 4 (e.g., a transflective film);

wherein the second lens 2 includes a third surface 21 and a fourth surface 22, the third surface 21 is close to the second surface 12 and is attached with a composite film, and the composite film includes the phase retarder 5, the polarization-reflecting element 6, and the polarization element 7 which are sequentially stacked; the phase retarder 5 is a quarter-wave plate, the polarization-reflecting element 6 is a polarization-reflecting film, and the polarization element 7 is a polarizing film, and the phase retarder 5 is located between the light-splitting element 4 and the polarization-reflecting element 6;

wherein the display screen 3 is, for example, 2.1 inches.

The specific optical parameters of the optical module are listed in Table 1 below.

TABLE 1

| Sur. | | | | | Semi- | Mech | | 4th | 6th | 8th |
|---|---|---|---|---|---|---|---|---|---|---|
| No | Type | Radius | Thickness | Material | Diameter | Semi-Dia | Conic | order | order | order |
| 0 | STANDARD | Infinity | −1500 | | 1500 | 1500 | 0 | 0 | 0 | 0 |
| 1 | STANDARD | Infinity | 13 | | 2 | 2 | 0 | 0 | 0 | 0 |
| 2 | EVEN | 200.00 | 4.00 | K26R | 14.5 | 15.8 | −4.996 | −5.08E−06 | −1.05E−07 | −4.75E−12 |
| | ASPH | | | | | | | | | |
| 3 | EVEN | −46.33 | 8.11 | | 15.8 | 15.8 | 3.774 | −2.14E−06 | 5.64E−09 | −1.67E−12 |
| | ASPH | | | | | | | | | |
| 4 | EVEN | −41.27 | −8.11 | MIRROR | 20.2 | 20.3 | 1.589 | 3.36E−06 | −9.49E−09 | −3.48E−13 |
| | ASPH | | | | | | | | | |
| 5 | EVEN | −46.33 | 8.11 | MIRROR | 15.8 | 15.8 | 3.774 | −2.14E−06 | 5.64E−09 | −1.67E−12 |
| | ASPH | | | | | | | | | |
| 6 | EVEN | −41.27 | 2.47 | K26R | 20.2 | 20.3 | 1.589 | 3.36E−06 | −9.49E−09 | −3.48E−13 |
| | ASPH | | | | | | | | | |
| 7 | STANDARD | Infinity | 0 | | 20.1 | 20.3 | 0 | 0 | 0 | 0 |
| 8 | STANDARD | Infinity | 0.4 | BK7 | 20.2 | 20.2 | 0 | 0 | 0 | 0 |
| 9 | STANDARD | Infinity | 0.44 | | 20.2 | 20.2 | 0 | 0 | 0 | 0 |
| 10 | STANDARD | Infinity | 0 | | 20.4 | 20.4 | 0 | 0 | 0 | 0 |

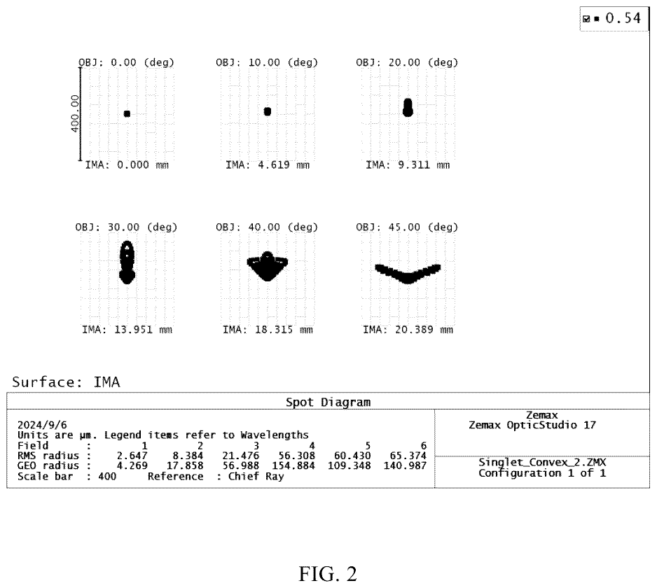

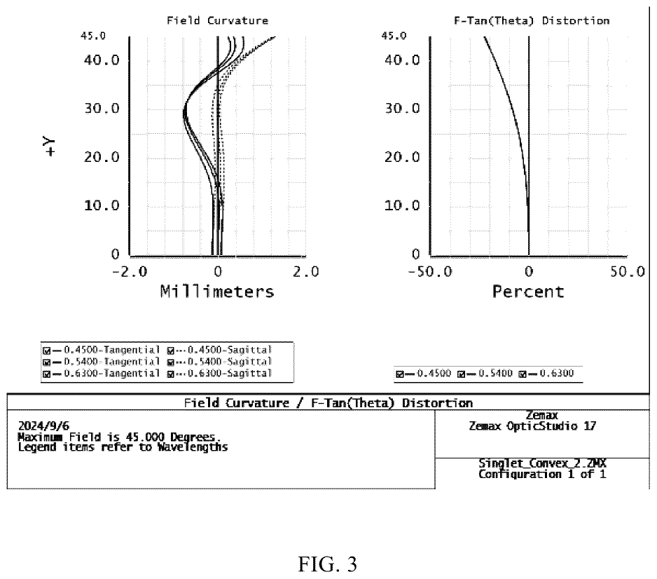

The optical module provided by this specific example demonstrates optical performance as shown in FIGS. 2 and 3: FIG. 2 shows the spot diagram, while FIG. 3 shows the field curvature and distortion diagrams.

The spot diagram refers to a dispersion pattern distributed within a certain range, formed when multiple light rays emitted from a single point no longer converge at a single point on the image plane after passing through the optical system due to aberration, serving to evaluate the imaging quality of the projection optical system. Referring to FIG. 2, for the optical module provided by this specific example, the maximum spot size in the spot diagram is less than 65 μm, indicating that the optical module maintains excellent imaging clarity across various viewing angles (the clarity being sufficient to meet user requirements for the smart head-mounted device).

Referring to FIG. 3, the optical module provided by this specific example exhibits field curvature below 1.3 mm and absolute distortion values less than 22.6% at full field of view (e.g., 90° with 0=45° in half-field of view). This demonstrates that the optical module produces minimal distortion during imaging, fully satisfying user imaging requirements for the smart head-mounted device.

In summary, the optical module provided by embodiments of the present disclosure may meet HMD application requirements for lightweight, low ghost images, and high imaging quality.

According to another embodiment of the present disclosure, a smart head-mounted device is provided, which includes a housing and the aforementioned optical module.

The smart head-mounted device provided by embodiments of the present disclosure may be, for example, a VR smart head-mounted device such as VR smart glasses or a VR smart helmet.

Specific implementations of the smart head-mounted device according to embodiments of the present disclosure may refer to the various embodiments of the aforementioned optical module, and therefore possess at least all the beneficial effects brought by the technical solutions of those embodiments, which will not be repeated herein.

The above embodiments focus on the differences between the various embodiments, and the different optimization features between the various embodiments, as long as they do not contradict each other, may be combined to form a better embodiment, which will not be repeated herein taking into account the brevity of the text.

Although some specific embodiments of the present disclosure have been described in detail through examples, those skilled in the art should understand that the above examples are for illustration only and are not intended to limit the scope of the present disclosure. Those skilled in the art should understand that the above embodiments can be modified without departing from the scope and spirit of the present disclosure. The scope of the present disclosure is defined by the accompanying claims.

1. An optical module, comprising a display screen, a first lens, and a second lens arranged along a mutual optical axis;
wherein the first lens is located between the display screen and the second lens, and the first lens comprises a plano-concave lens having a planar surface of the first lens bonded to the display screen;
the first lens has a light-splitting element provided on a surface thereof away from the display screen, the second lens has a phase retarder and a polarization-reflecting element stacked on a surface thereof facing to the display screen, and the phase retarder is located between the light-splitting element and the polarization-reflecting element.

2. The optical module according to claim 1, wherein an air gap is provided between the first lens and the second lens.

3. The optical module according to claim 2, wherein the optical module satisfies:
$$20 mm < 1 / 3 EFLL 1 < EFL All < 28 mm ;$$
$$20 mm < 1 / 3 EFLL 2 < EFL All < 28 mm ;$$
$$0. 5 * TTL < T < 0.6 * TTL ;$$
wherein EFL_{L1} is a focal length of the first lens, EFL_{L2} is a focal length of the second lens, EFL_{AII} is a total focal length of the optical module, and T is a linear distance between a second surface of the first lens and a third surface of the second lens.

4. The optical module according to claim 3, wherein the optical module satisfies:
$$- 50 mm < R 21 < R 12 < - 40 mm ;$$
$$- 5 < R 22 / R 21 < - 4 ;$$
$$2 mm < CTL 1 < C {T}_{L 2} < 4 mm ;$$
wherein R₁₂ is a radius of curvature of the second surface of the first lens, R₂₁ is a radius of curvature of the third surface of the second lens, R₂₂ is a radius of curvature of a fourth surface of the second lens, CT_{L1} is a center thickness of the first lens, and CT_{L2} is a center thickness of the second lens.

5. The optical module according to claim 3, wherein the optical module satisfies:
$$2 mm < C {T}_{L 1} < C {T}_{L 2} < 4 mm ;$$
$$3 < E {T}_{L 1} / C {T}_{L 1} < 4 ;$$
$$0.3 < E {T}_{L 2} / C {T}_{L 2} < 0.5 ;$$
wherein CT_{L1} is a center thickness of the first lens, ET_{L1} is an edge thickness of the first lens, CT_{L2} is a center thickness of the second lens, and ET_{L2} is an edge thickness of the second lens.

6. The optical module according to claim 5, wherein the optical module further satisfies:
$$5 < C {A}_{L 1} / ( E {T}_{L 1} + C {T}_{L 1} ) < 6 ;$$
$$3 < C {A}_{L 2} / ( E {T}_{L 2} + C {T}_{L 2} ) < 4 ;$$
wherein CT_{L1} is the center thickness of the first lens, ET_{L1} is the edge thickness of the first lens, CA_{L1} is the clear aperture of the first lens, CT_{L2} is the center thickness of the second lens, ET_{L2} is the edge thickness of the second lens, and CA_{L2} is a clear aperture of the second lens.

7. The optical module according to claim 1, further comprises a polarization element provided on a surface of the polarization-reflecting element on a side away from the phase retarder.

8. The optical module according to claim 7, wherein the light-splitting element comprises a transflective film, the phase retarder comprises a quarter-wave plate, the polarization-reflecting element comprises a polarization-reflecting film, and the polarization element comprises a polarizing film.

9. The optical module according to claim 1, wherein when a FOV of the optical module is not less than 90°, an optical total length thereof is ≤17.5 mm.

10. A smart head-mounted device, comprising:
a housing; and
the optical module according to claim 1, configured to be coupled with the housing.
